(19) United States
(12) Patent Application Publication
(10) Pub. No.: US 2026/0218596 A1
(43) Pub. Date: Jul. 30, 2026

(54) Modular Continuous Production System for Depleting Wells

(71) Applicant: WOODLANDS HOLDINGS WLL, Manama (BH)

(72) Inventors: Samer KAWA, Al Seef (BH); Fares KHAYAT, JLT Dubai (AE); Omar DANNAWI, Dammam (SA)

(73) Assignee: WOODLANDS HOLDINGS WLL, Manama (BH)

(21) Appl. No.: 19/145,677

(22) PCT Filed: Jan. 3, 2023
(86) PCT No.: PCT/IB2023/050027

§ 371 Date: Jul. 3, 2025

(51) Int. Cl. E21B 43/34; B01D 19/00

(52) U.S. Cl. CPC E21B 43/34; B01D 19/0063

(57) ABSTRACT

A modular hydrocarbon production system for depleting wells that uses a dual blowcase system for enabling uninterrupted continuous production from wells that have a lower wellhead pressure that the export pipeline. The system can be advantageously enhanced with additional separators, blowcases and gas compressors for maximising production as the wellhead pressure drops with time. The use of a novel control system for ensuring a continuous flow to export avoids batch processing of wellbore fluids.

### CROSS-REFERENCE TO RELATED APPLICATIONS

This application claims priority to PCT/IB2023/050027, filed Jan. 3, 2023, which is incorporated herein by reference in its entirety.

### FIELD OF INVENTION

This invention is for enhancing or enabling production of hydrocarbon producing wells when the producing wellhead pressure falls below the pressure required for export via flowline or pipeline to a downstream facility. In particular a modular hydrocarbon production system is described that uses blowcases, instead of mechanical pumps, driven by gas compression. A novel method involving at least two blowcases with inlet control enables a continuous production process.

### BACKGROUND OF INVENTION

As oil and gas wells produce from a reservoir the pressure inside the reservoir drops and over time increased water cut i.e., increasing proportion of produced water, as well as the reduced reservoir pressure, leads to the producing well head pressure to drop below the minimum pressure required to export the fluids: oil, water and gas into an export pipeline. For this stage of the production life of a well or a group of wells a localized production system near the wells is able to boost the pressure of the fluids sufficiently to overcome the export pressure so that continuous production is sustained.

Such a system will typically consist of an inlet separator(s) to separate the gas from the liquids, a pump(s) for pumping the liquids that is capable of boosting the pressure of said liquids above the export pressure and a gas compressor(s) for boosting the gas pressure above the export pressure. Typically, the export continues through the same export pipeline that was connected to the well(s) when the wellhead pressure(s) was sufficient to ensure flow into the export system. A minimum pressure differential is required to move the produced fluids after boosting by pump for liquids or by compressor for gases. Additionally, a further differential pressure is required between the producing wellhead(s) pressure and the inlet separator with a lower separator pressure than producing wellhead(s) pressure to create sufficient differential bottom hole pressure at the reservoir entry into the wellbore to optimize productivity.

For such systems, one of the more problematic choices is for the pumps. Traditional rotating machinery, besides requiring electrical power, which will have to be produced on site or require addition capital for electrification, thus increasing complexity of the deployed system, also has turndown ratios that result in inefficiencies as produced liquid volumes vary or drop. Especially as at such late stage of production the wells may produce in slugs, which creates significant variation in required export flow and boost rates for the liquids. These factors make the choice of rotating machinery pumps a difficult and expensive problem.

U.S. Pat. No. 3,486,297 assigned to Esso discloses the use of a secondary vessel to be utilised as a non-rotating pumping mechanism for boosting liquid pressure in the secondary vessel by introducing gas from a compressor that is above the export pressure into the top of the secondary vessel, while isolating it from the primary inlet separator, using this gas pressure to displace the liquids into the export pipeline. This enables a batch export process that will be described in more detail under the Prior Art description. Such a secondary vessel is typically termed a “blowcase” though some also refer to it as a “surge vessel”.

The use of such a blowcase system for boosting liquid export pressure is disclosed in PCT application WO 2016/200341 assigned to PTT and in PCT application WO 2015/183072 assigned to Petronas. Both of these descriptions disclose systems for exporting multiphase liquids from wellheads to export pipelines. They use the same batch process method as for the original submission of US '297. The problem with this batch process is that it is limiting, because while the blowcase is being boosted to export with higher pressure gas from the compressor it must be isolated from the inlet separator. Therefore, the inlet separator has a capacity limit for incoming liquids, especially if slug flow is occurring. This may result in the high-liquid-level safety for the inlet separator shutting in the production as there is nowhere for the liquids to go. This will increase the wellhead pressure and stop the upward flow of fluids in the production well(s), which in some cases will cause the production to stop subsequently requiring stimulation like swabbing to restart production.

There is a need for having a blowcase system that can operate continuously and that has a control system which can automatically and autonomously adjust the continuous export boosting process to ensure that it remains an uninterrupted continuous process.

The various implementations possible of the inventive idea have a broad application for enabling modularity of the production system as the production pressure continues to drop and this will be illustrated with various embodiments.

### SUMMARY

The present application relates to a hydrocarbon production system according to claim 1, with additional features as set out in dependent claims 2-14, and to a method of operating a hydrocarbon production system according to claim 15.

The system is a modular hydrocarbon production system for depleting wells that uses a dual blowcase system for enabling uninterrupted continuous production from wells that have a lower wellhead pressure that the export pipeline. The system can be advantageously enhanced with additional separators, blowcases and gas compressors for maximising production as the wellhead pressure drops with time. The use of a novel control system for ensuring a continuous flow to export avoids batch processing of produced wellbore liquids after separation. In normal use the flare gas system does not involve flaring as the gas is used for displacement of liquids.

The novel design has a multiple blowcase system that enables modular cost-effective expansion of the system to adjust for depleting production from one or more wells. The use of more than one blowcase coupled with a control system for ensuring continuous export of liquids creates a versatile modular production system which in one embodiment has the following main components:
i) An inlet line connected to one or more hydrocarbon producing wells;
ii) An Emergency Shut Down Valve on the inlet line;
iii) An inlet line flow control valve;
iv) At least one inlet separator with a level controller;
v) At least two blowcases, each with a level controller and associated actuated level control valves;
vi) A process logic for the inlet controller and the blowcase controllers;
vii) At least one stage of a gas compression system;
viii) A compressed gas export pressure control valve;
ix) An Emergency Shut Down valve on the gas export line;
x) At least one liquid export valve;
xi) At least one fuel gas processing system
xii) At least one flare gas system for intermittent use during upset conditions.

Ann inlet line to the modular production system may be fed by one or more producing wells producing at a pressure below the export line pressure. This inlet line may be tied in to at least one inlet separator with an inlet flow controller between the inlet line and the inlet separator. There may be an emergency shutdown valve upstream of the inlet flow controller.

The inlet flow controller may be driven by a level controller on the inlet separator that throttles the inlet flow controller for a high-level and opens the inlet flow controller for a low-level in the separator.

A dual blowcase continuous exporting system fills a first blowcase while emptying a second blowcase to deliver a continuous production flow to an export pipeline, whereby the blowcases are supplied with compressed gas at a higher pressure than the export pipeline.

Each blowcase may have a level controller with a high-level on a blowcase initiating a changeover from filling that blowcase to emptying it and a low-level on a blowcase initiating a changeover from emptying that blowcase to filling it. The level controls on the two blowcases are interlocked to ensure that one blowcase is always filling whilst the other is draining to maintain a continuous liquid flow.

A process logic method is described combining the inlet flow control and the blowcase draining control systems.

Produced gas from the inlet separator may be metered and supplied to a gas compression system with at least one stage of gas compression. The compressed gas may be exported at a pressure higher than the export line through a pressure control valve and another emergency shut down valve just before the export pipeline. Part of the compressed gas from the last stage may be used to drive the draining of the blowcases by differential pressure displacement.

The modular production system may have a fuel gas processing system that takes part of the compressed gas which after treating is used to fuel the gas engines for the compressors in the compression system.

A flare gas system may be provided that is not in normal use as all the gas is compressed and exported. It is designed for blowdown of the production system pressure during upset conditions or maintenance. It can also handle venting from pressure safety valves.

### BRIEF DESCRIPTION OF DRAWINGS

For a more complete understanding of the present invention, and the advantages thereof, reference is now made to the following descriptions taken in conjunction with the accompanying drawings, in which:

FIGS. 1a and 1b are simplified schematics to explain the prior art batch process using a single blowcase;

FIGS. 2a and 2b are simplified schematics to explain the continuous blowcase process with two blowcases;

FIG. 3 is a flowchart illustrating the switchover process used in the continuous blowcase processes illustrated in FIGS. 2a and 2b,

FIG. 3 is a flowchart illustrating a method of carrying out the continuous blowcase process;

FIG. 4a is logic sequence flow chart to determine the required gas compression modules for design of a modular production system based on pressure;

FIG. 4b is logic sequence flow chart to determine the required number of separators and blowcases for design of a modular production system based on volume;

FIG. 5 is a process block diagram for a modular production system with two blowcases;

FIGS. 6a to 6c are a Process and Instrumentation Diagram of an embodiment of a modular production system;

FIG. 7 is a logic sequence flowchart of the control system depicted in FIG. 6a,

### DETAILED DESCRIPTION OF THE INVENTIONS

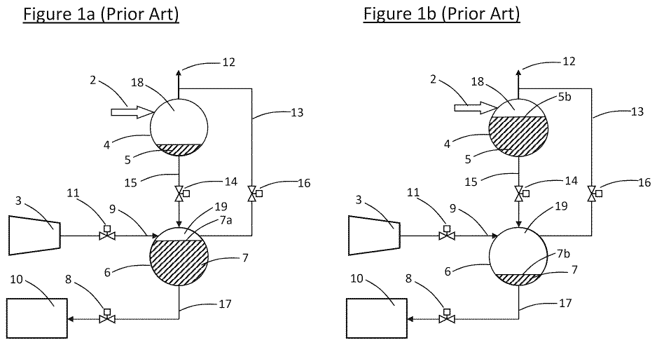

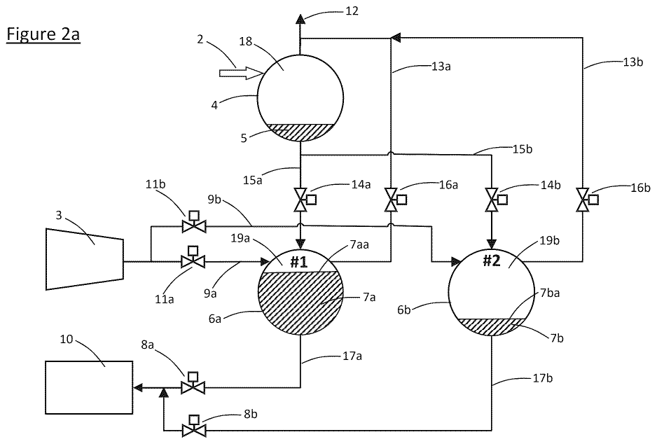

The problems being solved and the solutions provided by the embodiments of the principles of the present inventions are best understood by referring to FIGS. 1 to 6 of the drawings, in which like numbers designate like parts.

FIGS. 1a and 1b are simplified schematics to explain the prior art batch process using a single blowcase. Referring to FIG. 1a: we have an inlet separator 4 being supplied by an inlet flow line 2. The inlet separator 4 separates the incoming fluid flow to liquids 5 on the bottom and gas 18 at the top. The liquids will usually be a mixture of water and oil or condensate. The gas exits through line 12 to the gas compression system 3. The inlet separator 4 gravity feeds liquids 5 via line 15 through open valve 14 into a single blowcase 6. Inside the blowcase the liquids 7 accumulate. Valve 16 on the equalization line 13 is open to enable displacement of gas 19 from the top of the blowcase 6 to the inlet separator 4 as the liquids 7 level rises. Valve 8 on the drain line 17 of the blowcase is closed because the pressure in the blowcase 6 and inlet separator 4, being equalized via open valve 16 on the equalization line 13, is below the export pipeline 10 pressure. Valve 11 on the inlet line 9 from the gas compression system 3 is also closed.

Once the level of the liquids 7 in the blowcase 6 reaches a certain high-level 7a, the set point on a level controller (not shown) commences a draining sequence of the liquids 7. The level controller closes valves 14 and 16 on the lines 15 and 13 respectively. Now the inlet separator 4 is isolated from the blowcase 6. Then valve 11 is opened allowing gas from the compressor system 3 to enter the top 19 of the blowcase through line 9. This gas supply is at a higher pressure than the export line 10. Valve 8 is also opened and the higher-pressure gas displaces the liquids 7 into the export pipeline 10.

Referring now to FIG. 1b we see the status after this draining has occurred with the level of the liquids 7 having dropped to level 7b and gas occupying most of the blowcase 6 volume 19. At this stage a low-level setpoint will cause the level controller (not shown) to close valve 11 and valve 8, thus isolating the blowcase from the compression system 3 and the export pipeline 10 respectively. Then valve 16 is opened allowing the trapped pressure at top of blowcase 19 to equalize to inlet separator 4 pressure. During the earlier emptying of the blowcase 6, the volume of liquids 5 in the inlet separator continued to accumulate resulting in a higher level 5b. Then valve 14 on the drain line 15 is opened and the sequence of draining liquids to the blowcase 6 is restarted. This batch process, meaning that liquid export occurs in batches, has a drawback as it is fully reliant on the primary capacity of the inlet separator 4. If a large slug of liquid arrives, which is common with depleting reservoir production, while draining the blowcase 6, this can fill the inlet separator 4 above the maximum allowable level before the blowcase 6 is empty. As a consequence, an Emergency Shut Down valve (not shown) upstream of the Inlet separator 4 would close and this will in turn lead to a pressure increase for the producing wells, potentially interrupting production, an undesirable event for many reasons. This is why the invention described next gives the ability to avoid this by providing a continuous production, draining and displacement of liquids from the inlet separator 4 and blowcase 6 respectively into the export pipeline 10.

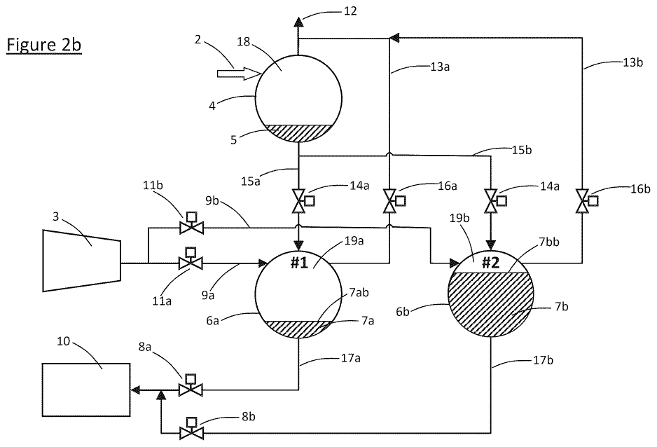

FIGS. 2a and 2b are simplified schematics to explain a novel continuous process using at least two blowcases. Referring to FIG. 2a: we have an inlet separator 4 having a fluid inlet which is supplied by an inlet flow line 2, a gas outlet and a liquid outlet. The inlet separator 4 separates the incoming fluid flow to liquids 5 on the bottom and gas 18 at the top. The gas exits through the gas outlet to line 12 which extends from an upper portion of the inlet separator 4 to a gas compression system 3. A first liquid supply line 15a, having a first liquid supply valve 14a which is movable between an open position in which fluid flow along the line is permitted and a closed position in which it blocks flow of fluid along the line, extends from the liquid outlet at a lowermost portion of the inlet separator 4 to a first blowcase 6a (#1 blowcase 6a), so that the inlet separator 4 gravity feeds liquids 5 via line 15a through open valve 14a into the #1 blowcase 6a. Inside the #1 blowcase 6a the liquids 7a accumulate. The liquids will usually be a mixture of water and oil or condensate. An equalization line 13a, having an equalization valve 16a which is movable between an open position in which fluid flow along the line is permitted and a closed position in which it blocks flow of fluid along the line, extends from an upper portion of the #1 blowcase to the gas outlet of the inlet separator 4. Equalization valve 16a in the equalization line 13a between the inlet separator 4 and the #1 blowcase 6a is open to enable displacement of gas 19a at the top of the #1 blowcase 6a as the liquids 7a level rises. A drain line 17a, having a drain valve 8a which is movable between an open position in which fluid flow along the line is permitted and a closed position in which it blocks flow of fluid along the line, extends from a lowermost portion of the #1 blowcase 6a to an export pipeline 10. Drain valve 8a on the drain line 17a of the #1 blowcase 6a is closed because the pressure in the #1 blowcase 6a and inlet separator 4, being equalized via open valve 16a on the equalization line 13a, is below the export pipeline 10 pressure. A first gas supply line 9a, having a first gas supply valve 11a which is movable between an open position in which fluid flow along the line is permitted and a closed position in which it blocks flow of fluid along the line, extends from the gas compression system 3 to #1 blowcase 6a. The first gas inlet valve 11a is also closed.

Once the level of the liquids 7a in the #1 blowcase 6a reaches a certain high-level set point 7aa on the level controller (not shown), this commences a draining sequence of the liquids 7a. The level controller closes valves 14a and 16a on the lines 15a and 13a respectively. Now the inlet separator 4 is isolated from the #1 blowcase 6a. Then valve 11a is opened allowing gas from the compressor system 3 to enter the top 19a of the #1 blowcase 6a through line 9a. This gas supply is at a higher pressure than the export line 10. Now valve 8a is opened and the higher-pressure gas displaces the liquids 7a into the export pipeline 10.

Continuing with FIG. 2a, we have a second liquid supply line 15b, having a second liquid supply valve 14b, which extends from the liquid outlet of the inlet separator 4 to a second blowcase 6b (#2 blowcase 6b). There a second gas equalization line 13b, having a second equalization valve 16b which is movable between an open position in which fluid flow along the line is permitted and a closed position in which it blocks flow of fluid along the line, which extends from an uppermost portion of the #2 blowcase 6b to the gas outlet of the inlet separator 4. The #2 blowcase 6b is isolated from the inlet separator 4 with valves 14b and 16b being closed on lines 15b and 13b respectively. There is a second gas supply line 9b, having a second gas supply valve 11b which is movable between an open position in which fluid flow along the line is permitted and a closed position in which it blocks flow of fluid along the line, extends from the gas compression system 3 to the #2 blowcase 6a. The second gas supply valve 11b is open on the second gas supply line 9b coming from the gas compression system 3. There is a second drain line 17b, having a second drain valve 8b which is movable between an open position in which fluid flow along the line is permitted and a closed position in which it blocks flow of fluid along the line, which extends from the lowermost portion of the #2 blowcase 6b to the export pipeline 10. The second drain valve 8b on line 17b is open to the export pipeline 10.

This #2 blowcase 6b is in the process of draining liquids 7b by displacement of high-pressure gas, at a higher pressure than the export pipeline 10, into the cavity 19b of the #2 blowcase 6b. As the liquids level drops to a low-level set point 7ba on the level controller (not shown), this commences a switching sequence, closing valve 11b followed by valve 8b. Then the pressure equalization valve 16b is opened followed by valve 14b opening that now enables the draining of liquids from inlet separator 4 into #2 blowcase 6b.

There is an interlock in the blowcase control system that is triggered either by a high-level 7aa or a low-level 7ba, whichever occurs first to commence the switchover of the sequence. So, if #1 blowcase 6a is full, as triggered by level 7aa, then even if blowcase #2 is not yet fully drained down to level 7ba, the change over to draining #1 blowcase 6a is initiated by first isolating #2 blowcase from high-pressure gas supply line 9b by closing valve 11b followed by valve 8b. Then the pressure equalization valve 16b is opened followed by valve 14b opening that now enables the draining of liquids from inlet separator 4 into #2 blowcase 6b.

Referring now to FIG. 2b we see the status after draining has occurred of #1 blowcase 6a and filling of #2 blowcase 6b is ongoing. Once the low-level 7ab is reached in #1 blowcase 6a or high-level 7bb is reached in #2 blowcase 6b then it will trigger the blowcase control system to switch over the filling and draining sequence as already described.

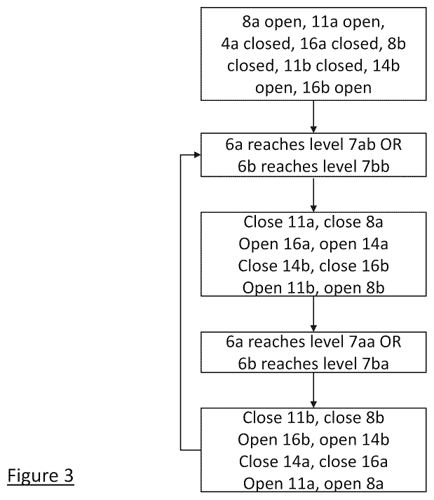

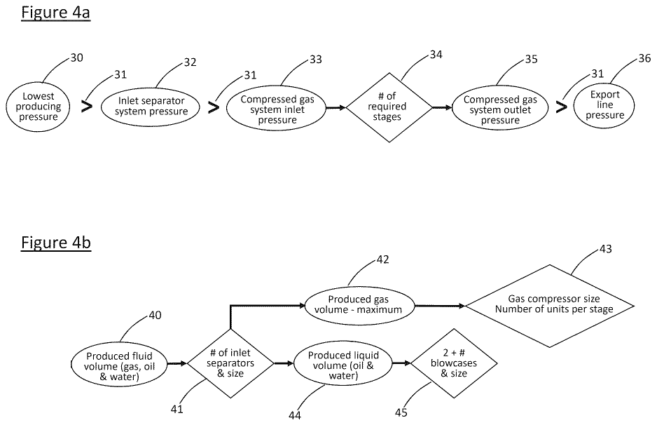

This switchover process is illustrated in FIG. 3. This flowchart shows the starting point A being when the #1 blowcase is draining, and the #2 blowcase is filling, so that valves 8a, 11a, 14b and 16b are open, whilst valves 14a, 16a, 8b and 11b are closed. When either the #1 blowcase 6a reaches level 7ab or the #2 blowcase reaches level 7bb, valves 11a and 8a are closed, valves 16a and 14a are opened, valves 14b and 16b are closed and valves 11b and 8b are opened. This switches the system so that #1 blowcase 6a is filling and #2 blowcase 6b is draining. Then, when either #1 blowcase 6a reaches level 7aa or #2 blowcase reaches level 7ba, the system switches back. Valves 11b and 8b are closed, valves 16b and 14 are opened, valves 14a and 16a are closed and valves 11a and 8a are opened. The system is then restored to the starting configuration in which the #1 blowcase is draining and the #2 blowcase 6b is filling. The process can then be repeated.

In this manner a continuous process of draining the inlet separator 4 is achieved and the trigger to switch blowcases can be any of the low-levels 7ba, 7ab or the high-levels 7aa, 7bb. This enables a seamless transition from one blowcase to another that is independent of the flowrates into the inlet separator at any point in time. This is very useful with the slug flow conditions that can occur in depleting production scenarios for which this system is designed. It enables the system to handle significant variations in liquid flow rates that are coming into the inlet separator.

This dual blowcase system may be tuned to have a fast drain cycle by having a higher differential pressure of high-pressure gas from the last stage of the compression system and increasing the bore of the drain lines 17a, 17b and the drain valves 8a and 8b. This means that the draining time can be made much shorter than the filling time. In this case the trigger for switching can be adjusted to only be the high-levels 7aa and 7bb in the #1 blowcase 6a and #2 blowcase 6b respectively.

If the time interval to drain one blowcase starts to approach the same time interval to fill a blowcase, or in the case of an upset condition for one of the blowcases, it is possible to have a scenario where the inlet separator 4 is not being drained fast enough. In this case an inlet flow controller can be part of the system that will throttle the incoming fluid flow from the producing wells. This will be explained later.

FIG. 4a shows a logic sequence flow chart to determine the required gas compression modules for design of a modular production system. The modular production system must provide gas compressed to a pressure 35 which is greater than (31) the export system pressure 36. It must be able to do this using incoming fluid at a pressure that is determined by the lowest producing pressure 30 of a well. Thee inlet separator system pressure 32 must be less than the lowest producing pressure 30 of the well (can be one or more separators), and the inlet separator system pressure 32 in turn has to be greater than (31) the minimum compressed gas system inlet pressure 33. The differential pressure between the gas compression outlet pressure 35 and the lowest estimated inlet gas pressure 33 determines the minimum number of gas compression stages required 34 for the system. Depending on the volumetric requirements there may be additional gas compression modules per stage.

FIG. 4b shows a logic sequence flow chart to determine the required number of separators and blowcases as well as gas compressor size/units per stage for the design of a modular production system. The number of inlet separators and size 41 is determined by the volume of produced fluids 40 and the inlet separator pressure 32 (FIG. 3a). These inlet separators are able to handle a certain maximum produced gas volume which then determines the size of the gas compressors for each stage and if more than one compressor is required for each stage. Based on the total produced liquids volume 44 the number and size of blowcases 45 per separator unit can be determined with a minimum of at least two blowcases for each separator to ensure a continuous process. A separator may have more than two blowcases that can be sequential for a three blowcase design or can be a parallel design of two plus two blowcases each set of two acting as a single blowcase.

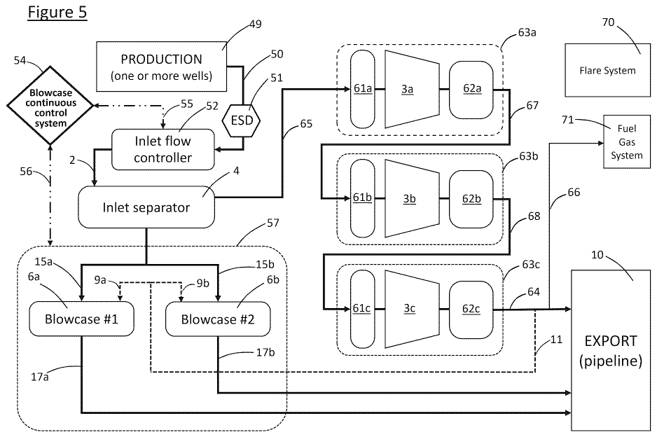

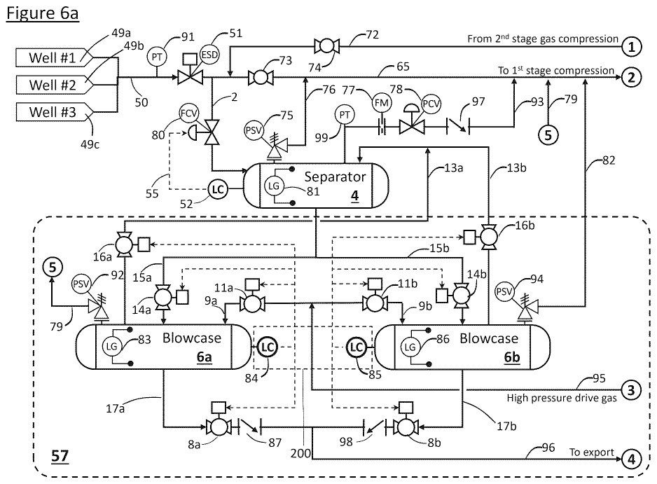

Referring to FIG. 5 which is a process block diagram for an embodiment of a modular production system with two blowcases. This shows a continuous modular production system that was modelled by the flowcharts of FIGS. 4a and 4b to create a process system consisting of:
i. An inlet line connected to one or more hydrocarbon producing wells;
ii. An Emergency Shutdown Valve on the inlet line;
iii. An inlet line flow controller;
iv. One inlet separator;
v. Two blowcases;
vi. A dual blowcase controller for continuous production;
vii. Three stages of a gas compression system;
Valves are not shown in this simplified block diagram.

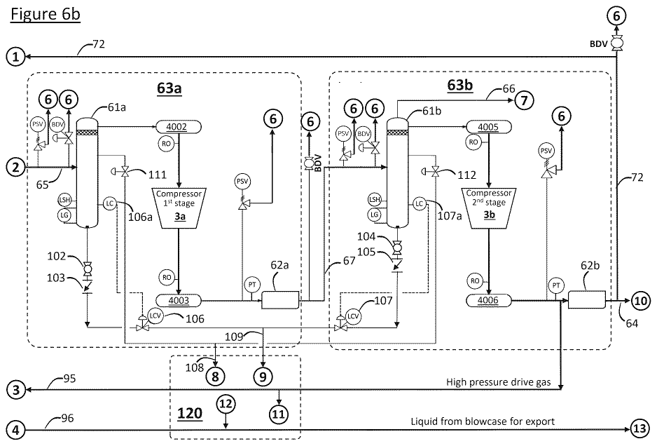

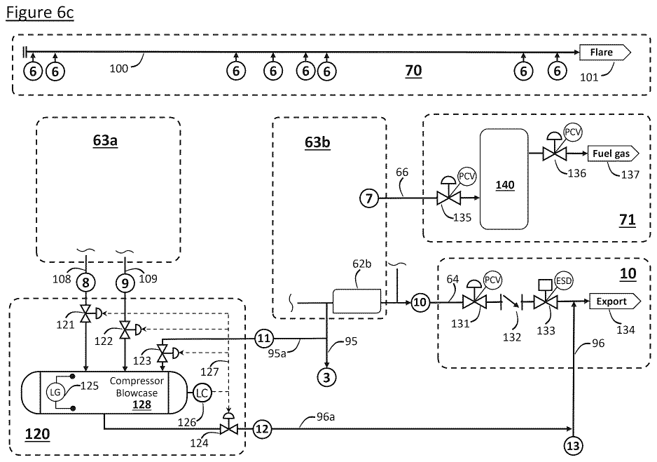

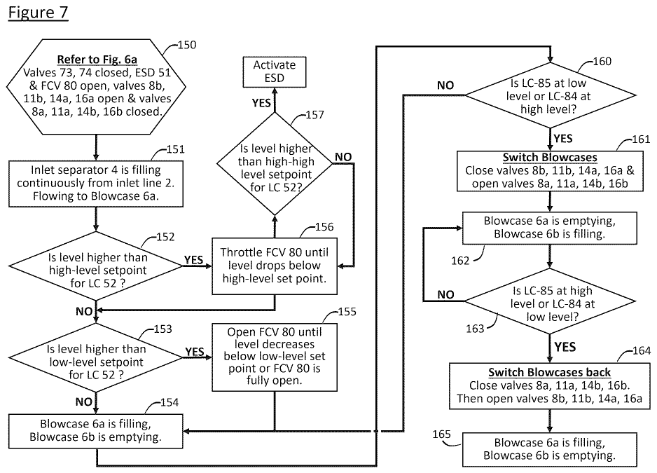

We have incoming production 49 from one or more wells into an inlet line 50 with an emergency shutdown valve 51 going to an inlet flow controller 52. The inlet flow controller 52 can be a throttling valve combined with differential pressure measurement of upstream and downstream pressure that is tied back to a continuous blow case control system 54. The full function of this control system is described in detail with FIG. 5a and the process logic of FIG. 6. After the production fluids pass the inlet flow controller 52, they go through line 2 into the inlet separator 4. Separated gas is sent through line 65 to the three stages 63a, 63b and 63c of gas compression.

Each stage compresses and cools gas to the next stage, so exit from stage 63a flows through line 67 to stage 63b which in turn flows through line 68 to the third stage 63c. Finally line 64 sends gas to the export pipeline 10 at a pressure 36 (FIG. 3a) higher than the lowest producing pressure 30 (FIG. 3a).

Each compression system 63a, 63b and 63c consists of a suction scrubber 61a, 61b, 61c, a gas compressor 3a, 3b, 3c and a discharge cooler 62a, 62b, 62c respectively. From the final stage gas line 64 there is a fuel gas line 66 that goes to a fuel gas system 71 that treats the gas suitable for the gas engines driving the gas compressors. Different pressure safety valves, blowdown and relief lines are connected to a flare gas system 70 (details not shown). From the final stage gas line 64 there is a gas supply line 11 that supplies gas to the blowcases 6a and 6b.

The inlet separator 4 has a split drain line 15a and 15b going to blowcases 6a and 6b respectively. As described in FIGS. 2a and 2b this blowcase system 57 is a continuous exporting system that can be drained alternately to export lines 17a and 17b by applying last stage compressor discharge gas through lines 11a and 11b to blowcases 6a and 6b respectively.

As described in the flow chart of FIG. 4a the compressed gas inlet pressure 33 requires three stages to boost the compressed gas outlet pressure 35 above the export line pressure 36. Using flowchart in FIG. 4b, this design required one inlet separator and the gas volumes 42 could be handled by single compressors for each compression stage. The number of blowcases was sized for two identical sized units based on the produced liquid volume 44.

FIGS. 6a to 6c are a single Process and Instrumentation Diagram of an embodiment of a modular production system that was designed using the process flowcharts of FIGS. 4a and 4b to create a process system consisting of:
i. An inlet line 50 connected to three hydrocarbon producing wells 49a, 49b and 49c;
ii. An Emergency Shutdown Valve 51 on the inlet line 50;
iii. An inlet line flow control valve 80;
iv. One inlet separator 4;
v. Two blowcases 6a and 6b creating a continuous blowcase draining system 57;
vi. Two blowcase level controllers 84 and 85 for continuous production;
vii. A process control logic for ensuring continuous uninterrupted export of produced liquids, FIG. 6;
viii. Two stages 63a and 63b of a gas compression system;
ix. One additional blowcase 128 that is part of a liquids exporting system 120 from compression liquid generation;
X. A gas export control valve 131;
xi. An Emergency Shut Down valve 133 on the gas export line;
xii. Two liquids export valves 8a and 8b;
xiii. A compressor blowcase 128 and system 120 for draining the compressor scrubbers;
xiv. One fuel gas processing system 71;
xv. One flare gas system 70;
xvi. A valve controller 200.

FIGS. 6a, 6b and 6c form one continuous drawing as follows: FIG. 6a is continued on FIG. 6b with circled numbers 1, 2, 3 and 4 on the right-hand side connecting to the corresponding circled numbers 1, 2, 3 and 4 on the left-hand side of FIG. 6b. From FIG. 6b the circled numbers 6, of which eight in number, lead to the corresponding circled numbers 6 on FIG. 6c to the flare gas system 70. From FIG. 6b circled connection points 7, 8, 9, 10, 11, 12 and 13 lead to the corresponding circled numbers 7, 8, 9, 10, 11, 12 and 13 on FIG. 6c. For simplicity the fuel gas lines from the fuel gas system 71 to the gas compressors 3a and 3b are not shown. Usually there is also a nitrogen purging system for the gas compressors, this is also not shown. The following abbreviations identify particular components, not all are described unless particular to the system of the invention: PT is pressure transducer, ESD is emergency shut down valve, FCV is flow control valve, PSV is pressure safety valve, FM is flow meter, PCV is pressure control valve, LC is level controller, LG is level gauge, BDV is blow down valve going to flare system, RO is restricting orifice, LCV is level control valve and LSH is level switch high. Where control lines are not critical to the invention they are not shown.

Referring to FIG. 6a we have three incoming production wells 49a, 49b and 49c going to an inlet line 50 with a pressure transducer 91 through an emergency shut down valve 51 via line 2 and through inlet flow control valve 80, which is usually fully open, to the inlet separator 4. Line 72 coming from 2^{nd} stage gas compression system 63b and line 65 going to 1^{st} stage gas compression system 63a are maintenance and start-up lines, not in use for the purposes of the explanation. Accordingly valves 73 and 74 are closed. We have three pressure vessels 4, 6a and 6b on this drawing that each have pressure safety valves 75, 92 and 94 respectively. All three of these safety valves vent to line 65 leading to 1^{st} stage gas compression system 63a through lines 76, 79 and 82 respectively. For PSV 92, the circled numbers 5 show the continuation of line 79 from PSV 92 to line 65.

Inlet separator 4 has a level gauge 81 and gas outlet line 93 going to 1^{st} stage gas compression system 63a through line 65. On the separator 4 gas outlet line we have a flowmeter 77, pressure control valve 78 and check valve 97. The pressure control valve 78 controls the pressure in the inlet separator based on a set-point pressure 32 (FIG. 4a) that is measured by pressure transducer 99. This pressure setpoint 32 should be lower than the lowest producing pressure 30 (FIG. 4a) of any of the wells 49a to 49c. The inlet separator has a level controller 52 that can control the flow control valve 80 through control line 55. This is an additional safeguard system in case the continuous draining system 57 is unable to handle the rate of flow coming through lines 50, 2. This could happen if there is a significant slug from any one of the producing wells 49a to 49c. This would cause the level in the separator 4 to increase and once the level controller detects a level above the setpoint, which would typically be about 50% of the maximum level allowable for the separator 4, the flow control valve 80 would throttle to stop the level increasing above the 50% setting. Once the continuous draining system 57 drains to lower the level below 50%, the flow control valve 80 will open and eventually be fully open again.

Referring now to the continuous draining system 57. This is the same system as described in relation to FIGS. 2a, 2b and 3, with like parts numbered the same. We have incoming line 95 supplying high pressure gas from the 2^{nd} stage compressor outlet supplying lines 9a and 9b. We have the drain lines 17a and 17b going through valves 8a with check valve 87 and valve 8b with check valve 98 respectively going to the export line 96. As the operation has already been described with FIGS. 2a,2b and 3, the focus is more on the level control system. Blowcase 6a has a level gauge 83 and a first valve controller 84 that control the function of the valves 8a, 11a, 14a and 16a as shown by the dotted control lines from the valve controller 84 to each valve. Similarly, blowcase 6b has a level gauge 86 and a second valve controller 85 that control the function of the valves 8b, 11b, 14b and 16b as shown by the dotted control lines from the valve controller 85 to each valve. The valve controllers 84, 85 may be separate and interconnected or be combined together form a single valve controller 200. The function of this system will be explained later with the flow chart in FIG. 7.

Continuing with the description of the modular production system on FIG. 6b, we have the incoming line 65 from the inlet separator gas outlet 93 supplying 1^{st} stage gas compression system 63a. Focusing on this system we have a pressure safety valve and a blowdown valve, normally closed, on the inlet of the scrubber 61a both having exhausts to the flare system 70. From the top of the inlet scrubber 61a we have the gas outlet going through a pulsation dampener 4002 and restricting orifice (RO) to the gas compressor 3a. Then the gas goes through another restricting orifice (RO) and pulsation dampener 4003 through a cooler 62a. Upstream of the cooler 62a is a pressure transducer (PT) and a pressure safety valve (PSV) going to the flare system 70. There is a blowdown valve (BDV), normally closed between cooler 62a and scrubber 61b leading to the flare system 70.

From the cooler 62a through line 67 we enter the 2^{nd} stage gas compression system 63b. Focusing on this system we have a pressure safety valve (PSV) and a blowdown valve (BDV), normally closed, on the inlet of the scrubber 61b both having exhausts to the flare system 70. From the top of the inlet scrubber 61b we have the gas outlet going through a pulsation dampener 4005 and restricting orifice (RO) to the gas compressor 3b. Then the gas goes through another restricting orifice (RO) and pulsation dampener 4006 through a cooler 62b. Upstream of the cooler 62b is a pressure transducer (PT) and a pressure safety valve (PSV) going to the flare system 70. The outlet of the 2^{nd} stage compressor is line 64 going to the export system 10. There is a blowdown valve (BDV) between cooler 62b and export system 10 on line 72 leading to the flare system 70.

The compression inlet scrubbers 61a and 61b are tied into their own blowcase draining system 120 and the function of this is now described by referring to both FIGS. 6b and 6c at the same time. Each scrubber 61a and 61b has a level gauge (LG) and a level switch high (LSH) which can initiate a shut down if the liquid level is too high. Referring to FIG. 6b, scrubber 61a has a liquid outlet on bottom going through a normally open valve 102 and a check valve 103 to level control valve (LCV) 106 controlled by level controller 106a. Similarly, scrubber 61b has a liquid outlet on bottom going through a normally open valve 104 and a check valve 105 to level control valve (LCV) 107 controlled by level controller 107a. Both of the LCVs, 106 and 107 feed into a common header 109, the liquid drain, that goes through valve 122 into the compressor blowcase 128.

Scrubbers 61a and 61b have a pressure equalization outlet going through valves 111 and 112 respectively going to common header 108, pressure equalization, that goes through valve 121 into the top of the compressor blowcase 128. The compressor blowcase has a high-pressure gas supply line 95a, that is coming off the main high-pressure gas line 95, that leads through valve 123 into the top of the compressor blowcase 128. The compressor blowcase 128 has a drain on the bottom that goes through valve 124 to line 96a that ties back into the main export line 96 going to the export system 10. The compressor blowcase has a level gauge 125 and a level controller 126 that controls the valves 121, 122, 123 and 124 through control lines 127.

Valves 111 and 112 on scrubbers 61a and 61b respectively are interlocked, meaning only one of them may be open at any one time. They control the equalization pressure inside the compressor blowcase 128 to be either the pressure in scrubber 61a or scrubber 61b.

The operation of the compressor blowcase system 120 is now described in two stages. The first stage is alternate draining of the scrubber vessels to the compressor blowcase 128. For this stage, valves 123 and 124 are closed while valves 121 and 122 are open. Valves 102 and 104 are normally open as already mentioned. The level control valves 106 and 107 are closed as the levels in the scrubbers 61a and 61b are low. Valve 111 is open and therefore valve 112 is closed, so the compressor blowcase 128 pressure is the same as the scrubber pressure 61a. As liquid is knocked out by the scrubbers 61a and 61b the levels inside the vessels starts to rise. Assuming now the case of a level reached that is high enough, high-level setpoint, to warrant draining, the level controller 106a will open the level control valve 106 and drain the level in scrubber 61a to a low-level setpoint. This can continue as often as required. Should the level controller 107a detect a high-level setpoint in scrubber 61b, then it will close valve 111 and open valve 112. Now the compressor blowcase 128 is at the same pressure as the scrubber 61b and the level control valve 107 can drain the scrubber 61b to a low-level setpoint. The system remains in this state until a high-level in scrubber 61a initiates another change over. In this manner the two scrubbers can alternately drain to the compressor blowcase.

Now for the second stage which describes the filling and draining of the compressor blowcase. We continue with the valve positions as is: 123 and 124 closed, 121 and 122 open. As the level rises in the compressor blowcase to a high-level setpoint the level controller 128 closes valves 121 and 122, then opens valve 123 putting 2^{nd} stage compression pressure (high-pressure) into the blowcase 128. Now opening valve 124 drains the compressor blowcase to a low-level setpoint and then valves 124 and 123 are closed followed by opening valves 121 and 123 putting the compressor blowcase back at either scrubber 61a or scrubber 61b pressure ready to continue draining them as required.

Referring to FIG. 6c to complete the description for the modular production system. We have the flare system 70 having a flare header 100 leading to a flare 101. Details like ignition system and pilot gas are not shown. The flare header receives all the tie-ins depicted by circled 6 coming from the various pressure safety valves and blowdown valves in the system. The modular production system does not have any flaring during normal operations.

The fuel gas system 71 takes gas from 2^{nd} stage scrubber through line 66 and the fuel gas system has a pressure control valve 135 on inlet and one pressure control valve 136 on outlet with a treater 140 in the middle. Fuel gas goes to a header 137 that supplies the gas engines for the compressors, detail not shown.

The export system 10 has the main incoming flow from 2^{nd} stage compression system 63b regulated by pressure control valve 131 to ensure the pressure is above the export line 134 pressure as discussed in FIG. 4a. A check valve 132 ensures no reverse flow from the export line 134 and an emergency shutdown valve 133 can be closed to isolate completely if an upset condition requires this. There is a tee between the valve 133 and the main export line that receives the liquids from the blowcase system 57 through line 96.

Referring to FIG. 7 we have a logic sequence flow chart that illustrates how the control systems may be used for such a dual blowcase system as illustrated in FIG. 6a. The focus of this logic sequence is the handling of liquids after the initial separation of the gas. Starting position 150 gives the valve positions for a normal condition whereby fluids from the producing wells 49a, 49b and 49c are flowing through line 50 and line 2 to the inlet separator 4.

Ongoing process 151 has the fluids being separated in the inlet separator 4 with gas going to the compression system 63a and liquids, oil and water, flowing to #1 blowcase 6a. #2 blowcase 6b is emptying or may be empty. For understanding the three decision boxes 152, 153 and 157: the level controller 52 has three setpoints, a high-level, a low-level and a high-high-level. For decision box 152 if there is no high-level for level controller, then the logic proceeds to decision box 153 which checks if the level is above the low-level setpoint. If not, then process continues as normal in process box 154 with blowcase 6a filling and blowcase 6b empty or emptying.

Referring to decision box 152, if the level in inlet separator 4 is higher than the high-level set point for level controller 52, then this means that the incoming fluid stream from line 2 is producing more liquids than the inlet separator 4 can drain to the blowcase 6a. In this case, yes, then the process will throttle the flow control valve 80 until the level drops below the high-level setpoint and the process can continue through decision box 153 to ongoing process box 154.

From process box 156, it is possible that the cause of the increasing fluid level in the inlet separator 4 may be due to an upset condition downstream of the separator liquids outlet rather than high slug volume production. In this case the level could continue to rise and escalate to decision box 157. If the level goes above the high-high level setpoint it means the system is no longer safe to continue operating as there may be significant liquid carry over to the gas compression system 63a. If yes, then the emergency shut down system is activated which will also close emergency shutdown valve 51, cutting off the incoming flow stream. If no, then throttling continues in process box 156 until level in separator 4 is below the high level setpoint

In decision box 153, if the level is above the low-level setpoint, so yes, then process box 155 instructs to open flow control valve 80 until fully open, or it may already be fully open, both conditions leading to continued process box 154. This has covered a possible logic for the inlet control system.

The continuation of the process control logic now deals with the functions of the dual blowcase system for continuous draining. This is ongoing from process box 151, but for simplicity of illustration it is shown after process box 154. Decision box 160 refers to the levels in blowcase 6a and blowcase 6b by level controllers 84 and 85 respectively. As blowcase 6b is emptying, for the decision box 160, if blowcase 6b is empty is yes, then the level control valves are opened and closed as per process box 161, to switch blowcase operation.

For this exemplary logic sequence, irrespective of whether blowcase 6b is empty or not, once blowcase 6a is determined full as determined by continuous process monitoring of the level controller 84, and decision logic 160, then the switchover of the blowcases is initiated by process box 161.

Process box 161 gives the exact valve switching sequence to stop filling blowcase 6a and to start emptying it while blowcase 6b starts receiving liquids from the inlet separator 4 as shown in process box 162. From process box 162 the logic continues as per decision box 163 which now has the opposite logic of decision box 160 in that it is checking for high-level on level controller 85 and low level on level controller 84. When the conditions are met, i.e. YES then the process box 164 shows the blowcases switched back again by the sequence of valves detailed. Now we reach process box 165 which is the same as process box 154 thus completing a full continuous cycle. In this manner a continuous draining logic for operation of two blowcases with one inlet separator is demonstrated.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the scope of the invention.

1. A hydrocarbon production system comprising:
at least one inlet separator comprising a fluid inlet, a gas outlet and a liquid outlet;
an inlet flow line which is configured to be connected to one or more hydrocarbon producing wells and which extends to the fluid inlet of the inlet separator;
a plurality of blowcases each comprising a liquid inlet, a liquid outlet, a high-pressure gas inlet and a pressure equalization outlet;
at least one gas compression system;
a liquid export line;
a drain line associated with each blowcase, each drain line being provided with a drain valve, the drain lines extending from the liquid outlet of the associated blowcase to the liquid export line;
a gas supply line associated with each blowcase, each gas supply line having a gas supply valve, each gas supply lines extending from the gas compression system to the high pressure gas inlet of the associated blowcase;
a liquid supply line associated with each blowcase, each liquid supply line having a liquid supply valve, which extends from the liquid outlet of the inlet separator to the liquid inlet of the associated blowcase; an equalization line associated with each blowcase, each equalization line having an equalization valve, which extends from the equalization outlet of the associated blowcase to the gas outlet of the inlet separator;
a valve controller that controls operation of the drain valves, the gas supply valves, the liquid supply valves, and the equalization valves, the valve controller being configured to control the valves so that at least one blowcase is in a fill state in which the associated liquid supply valve, and the associated equalization valve are open while the associated drain valve and associated gas supply valve are closed, and at least one blowcase is in a drain state in which the associated liquid supply valve, and the associated equalization valve are closed whilst the associated drain valve and the associated gas supply valve are open.

2. A system according to claim 1 wherein each blowcase has a liquid level sensor which is arranged on the blowcase to sense the liquid level in the blow case, each liquid level sensor being connected to the valve controller, the valve controller being configured, when the liquid level sensor associated with a blowcase in the fill state detects that the liquid level in the associated blowcase has reached a predetermined maximum level, or when the liquid level sensor associated with a blowcase in the drain state detects that the liquid level in that blowcase has fallen to a predetermined minimum level, to move the blowcase that is in the fill state to the drain state and the blowcase that is in the drain state to the fill state.

3. A hydrocarbon production system according to claim 1 comprising:
a first blowcase and a second blowcase each comprising a liquid inlet, a liquid outlet, a high-pressure gas inlet and a pressure equalization outlet;
at least one gas compression system;
a liquid export line;
first and second drain lines, the first drain line being provided with a first drain valve and the second drain line being provided with a second drain valve, the first and second drain lines extending from the liquid outlet of the first and second blowcase respectively to the liquid export line;
a first and second gas supply line, the first gas supply line having a first gas supply valve and the second gas supply line having a second gas supply valve, the first and second gas supply lines extending from the gas compression system to a respective one of the first and second blowcases;
first and second liquid supply lines, the first liquid supply line having a first liquid supply valve and the second liquid supply line having a second liquid supply valve, which extend from the liquid outlet of the inlet separator to the liquid inlet of a respective one of the first and second blowcases;
first and second equalization lines, the first equalization line being provided with a first equalization valve and the second equalization line being provided with a second equalization valve, which extend from the equalization outlet of a respective one of the first and second blowcase to the gas outlet of the inlet separator;
a valve controller which controls operation of the drain valves, the gas supply valves, the liquid supply valves and the equalization valves, the valve controller being configured to control the valves to change the system from a first state in which the first liquid supply valve, the first equalization valve, the second drain valve and the second gas supply valve are open whilst the second liquid supply valve, the second equalization valve, the first drain valve and the first gas supply valve are closed, and a second state in which the first liquid supply valve, the first equalization valve, the second drain valve and the second gas supply valve are closed whilst the second liquid supply valve, the second equalization valve, the first drain valve and the first gas supply valve are open.

4. The system according to claim 3 further comprising a first liquid level sensor which is arranged on the first blowcase to sense the liquid level in the first blow case and a second liquid level sensor which is arranged on the second blowcase to sense the liquid level in the second blowcase, the first and second liquid level sensors being connected to the valve controller, the valve controller being configured to move the system from the first state to the second state when the first liquid level sensor detects that the liquid level in the first blowcase has reached a predetermined maximum level, or when the second liquid level sensor detects that the liquid level in the second blowcase has fallen to a predetermined minimum level, and to move the system from the second state to the first state when the first liquid level sensor detects that the liquid level in the first blowcase has fallen to a predetermined minimum level, or when the second liquid level sensor detects that the liquid level in the second blowcase has reached a predetermined maximum level.

5. The system according to claim 1, further comprising an inlet flow control valve which is provided in the inlet flow line and which is operable to vary the rate of fluid flow along the inlet flow line and into the inlet separator and a third liquid level sensor which is arranged in the inlet separator and which is operable to sense the liquid level in the inlet separator, wherein the valve controller is configured to control operation of the inlet flow control valve to reduce the rate of flow of fluid into the inlet separator when the third liquid level sensor detects that the liquid level in the inlet separator has exceeded a predetermined high level, and to control operation of the inlet flow control valve to increase the rate of flow of fluid into the inlet separator when the third liquid level sensor detects that the liquid level in the inlet separator has fallen below a predetermined minimum level.

6. The system according to claim 5 further comprising an emergency shut down valve which is provided in the inlet flow line upstream of the inlet flow control valve which is operable to move between an open position in which flow of fluid along the inlet flow line is permitted and a closed position in which flow of fluid along the inlet flow line to the flow control valve is substantially prevented, and the valve controller is configured to move the emergency shut down valve from the open position to the closed position if the third liquid level sensor detects that the liquid level in the inlet separator has exceeded a predetermined maximum level, the maximum level being higher than the predetermined high level.

7. The system of claim 1, wherein the gas compression system comprises one or more gas compression assemblies each comprising a suction scrubber, a gas compressor and a discharge cooler.

8. The system of claim 7 wherein for each gas compression assembly, the suction scrubber has an inlet and an outlet which is connected to an inlet of the gas compressor, an outlet of the gas compressor being connected to an inlet of the discharge cooler, and wherein the outlet of the gas compressor of the or a final one of the gas compression assemblies is connected to each of the blowcases via the associated gas supply line.

9. The system according to claim 1, wherein the gas compression system comprises a plurality of gas compression assemblies each having a gas inlet and a gas outlet, wherein the gas inlet of a first one of the gas compression assemblies is connected to the gas outlet of the inlet separator, and the gas outlet of a final one of the gas compression assemblies is connected to each of the blowcases via the associated gas supply line, and the gas outlet of the first gas compression assembly is connected to the gas inlet of the final gas compression assembly either directly or via the each of any other gas compression assembly.

10. The system according to claim 7 further comprising a compressor blowcase which has a liquid inlet port, and a drain port, and wherein the or each suction scrubber is connected to the liquid inlet port of the compressor blowcase via a drain line and a scrubber drain valve, each of which is configured to open to allow flow of liquid from the suction scrubber to the compressor blowcase when the liquid level in the suction scrubber exceeds a predetermined level.

11. The system according to claim 10 wherein the drain port of the compressor blowcase is connected to the liquid export line.

12. The system according to claim 10 wherein the compression blowcase has a high-pressure gas inlet port which is connected to an outlet of gas compressor of the or a final one of the gas compression assemblies via a compression blowcase gas supply valve.

13. The system according to claim 10 wherein the compression blowcase has a gas equalization port which is connected to each suction scrubber via a compression blowcase pressure equalization valve.

14. The system according to claim 1, wherein the inlet separator, each blowcase is provided with a pressure relief line which extends from the respective one of the inlet separator, and blowcases to the gas compression system via a pressure safety valve which is normally closed, thus preventing flow of fluid along the pressure relief line, the pressure safety valve being operable to open to allow flow of fluid along the pressure relief line when the pressure in the respect one of the inlet separator, and blowcases exceeds a predetermined maximum level.

15. The system according to claim 1, wherein the gas outlet of the inlet separator is connected to the gas compression assembly via a gas outlet line in which is provided a pressure control valve which is operable to increase or decrease the rate of flow of gas along the gas outlet line to maintain the pressure in the inlet separator around a predetermined level.

16. A method of controlling a hydrocarbon production system according to claim 1, the method comprising, when the liquid level in a blowcase in the fill state has reached a predetermined maximum level, or when the liquid level in a blowcase in the drain state has fallen to a predetermined minimum level, to move the blowcase that is in the fill state to the drain state and the blowcase that is in the drain state to the fill state.
